(19) United States
(12) Patent Application Publication
(10) Pub. No.: US 2011/0102259 A1
(43) Pub. Date: May 5, 2011

(54) Augmenting GNSS User Equipment to Improve Resistance to Spoofing

(75) Inventors: Brent M. Ledvina, San Francisco, CA (US); Todd E. Humphreys, Austin, TX (US); William J. Bencze, Half Moon Bay, CA (US); Bryan T. Galusha, San Francisco, CA (US); Clark E. Cohen, Washington, DC (US)

(73) Assignee: COHERENT NAVIGATION, INC., San Mateo, CA (US)

(21) Appl. No.: 12/889,238

(22) Filed: Sep. 23, 2010

Related U.S. Application Data
(60) Provisional application No. 61/245,658, filed on Sep. 24, 2009.
(60) Provisional application No. 61/245,652, filed on Sep. 24, 2009.
(60) Provisional application No. 61/245,655, filed on Sep. 24, 2009.

(51) Int. Cl. G01S 19/21

(52) U.S. Cl. 342/357.59

(57) ABSTRACT

A method of countering GNSS signal spoofing includes monitoring a plurality of GNSS signals received from a plurality of GNSS signal sources and comparing broadcast data to identify outlying data, which is excluded from generation of a navigation solution defined by the plurality of GNSS signals. The outlying data can be a vestigial signal from a code or carrier Doppler shift frequency. The method includes triggering a spoofing indicator upon identification of the outlying data or other phenomenon. The phenomenon can include a shift in a phase of a measured GNSS navigation data bit sequence or a profile phenomenon of a correlation function resulting from correlation of the incoming GNSS signals with a local signal replica. The profile phenomenon can be the presence of multiple sustained correlation peaks. A nullifying signal can be generated and superimposed over a compromised signal.

### CROSS-REFERENCE TO RELATED APPLICATIONS

This application claims priority to provisional application No. 61/245,658, filed Sep. 24, 2009, titled “Augmenting GNSS User Equipment to Improve Resistance to Spoofing”; 61/245,652, filed Sep. 24, 2009, titled “Simulating Phase-Aligned GNSS Signals”; and 61/245,655, filed Sep. 24, 2009, titled Assimilating GNSS Signals to Improve Accuracy, Robustness, and Resistance to Spoofing, which are incorporated herein in their entireties by reference.

### TECHNICAL FIELD

This invention relates to GNSS signal security, and more particularly to GNSS signal spoofing countermeasures.

### BACKGROUND

There exist in the military and civil sectors hundreds of thousands of Global Navigation Satellite System (GNSS) receivers that are susceptible to GNSS signal spoofing. Spoofing is a pernicious type of intentional interference whereby a GNSS receiver is fooled into tracking counterfeit GNSS signals. Intentional GNSS spoofing in the proximity of a GNSS receiver can force the receiver to lose lock on authentic GNSS signals, degrade its estimates of position, velocity, and time (PVT), or render its PVT estimate wholly inaccurate and incorrect.

In many cases, the GNSS receivers are coupled to avionics, communication, measurement, timing or other equipment that depends crucially on the timing signals or navigation data that the GNSS receiver provides. When the steady stream of position, velocity, and time data on which this equipment relies is surreptitiously commandeered by a spoofer, the dependent equipment can cease to function or can malfunction, with potentially disastrous consequences.

Accordingly, improvements are sought in GNSS signal receiver security.

### SUMMARY

A GNSS Anti-Spoofing Module provides spoofing detection and spoofing countermeasures. In the presence of a spoofing attack, the GNSS receiver user is warned about the ongoing spoofing attack or, alternatively, the spoofing attack is detected and prevented from affecting the GNSS receiver's PVT estimate.

Spoofing Detection

Stand-alone commercial civilian GNSS receivers available today are generally easily spoofed. One simply attaches a power amplifier and an antenna to a GNSS signal simulator and radiates a false RF signal toward the target receiver.

Military-grade GNSS receivers are capable of operating in a spoof-resistant mode in which the receiver tracks an encrypted ranging code that is unpredictable except to compliant and keyed user equipment. However, in practice, many military personnel fail to maintain the cryptographic keys in their GNSS user equipment or prefer to carry civil GNSS receivers, with the result that a large fraction of GNSS receivers in military service are vulnerable to spoofing.

In some implementations, the GNSS Anti-Spoofing Module detects the presence of GNSS spoofing by employing detection methods and by validating incoming GNSS signals against other available navigation and timing sources as described below.

In another implementation, the GNSS Anti-Spoofing Module initially acts as a stand-alone spoofing detector, uncoupled from any target receiver. When a spoofing attack is detected, the Anti-Spoofing Module raises an alarm. This implementation may be attractive to users who are wary of spoofing but who otherwise prefer an untethered GNSS receiver.

In still another implementation, the GNSS Anti-Spoofing Module is integrated into a GNSS receiver. The GNSS Anti-Spoofing Module can provide spoofing detection and countermeasure strategies as described above. This option may be attractive, for example, to users who want an integrated receiver with anti-spoofing capabilities built-in. Augmentation with the GNSS Anti-Spoofing Module is particularly cost-effective where the anti-spoofing module itself is less expensive than replacing existing user equipment with a new model as capable as the anti-spoofing-module-receiver pair.

One method of enabling spoofing detection is to use a diversity of GNSS observables to estimate PVT. The likelihood that many signals from multiple GNSSs (e.g., Galileo, GPS, NAVSTAR, GLONASS, and Beidou) are being spoofed simultaneously is relatively low.

Another method to enable spoofing detection is to utilize observables from non-GNSS navigation and timing signals such as those used in LORAN and ELORAN systems.

Another method to enable spoofing detection is to utilize observables from radio frequency signals that are not expressly classified as radionavigation signals, but nonetheless contain navigation-or-time-bearing signatures. For instance, it has been determined that television signals, cellular telephone signals, and satellite communication signals, e.g., IRIDIUM™, can be exploited for navigation and timing.

Spoofing Countermeasures

In some applications, the Anti-Spoofing Module prevents a spoofing attack from affecting a GNSS receiver. Utilizing one or more of the above detection methods enables the Anti-Spoofing Module to detect GNSS signals that are being spoofed. Remaining observables from signals that are unaffected by spoofing can be used by a nonlinear least-squares estimator to relate antenna position, velocity, and time to the observables. The resultant spoof-free estimate of position, velocity, and time can be used to synthesize a new set of “clean” GNSS signals using a GNSS signal simulator such as the one described in the Applicants' copending application Ser. No. ______, filed Sep. ______, 2010, titled “Assimilating GNSS Signals to Improve Accuracy, Robustness, and Resistance to Signal Interference,” the entirety of which is incorporated herein by reference. These clean GNSS signals are output from the GNSS Anti-Spoofing Module thereby providing a spoof-free set of GNSS radionavigation signals to the target GNSS receiver, and protecting the receiver from spoofing.

In some applications, a method of countering GNSS signal spoofing includes monitoring a plurality of GNSS signals received from a plurality of GNSS signal sources and comparing data broadcast in the plurality of GNSS signals to identify outlying data within a compared set of data. The outlying data is excluded from generation of a navigation solution defined, at least in part, by the data broadcast in the plurality of GNSS signals.

In some applications, the monitoring includes receiver autonomous integrity monitoring (“RAIM”).

In some applications, the outlying data includes a vestigial signal in one of a code and carrier Doppler shift frequency.

In some applications, the comparing includes logging a carrier-to-noise ratio (C/N0) time history for the plurality of GNSS signals and the identifying includes identifying sudden phase shifts larger than a predetermined threshold.

In some applications, the monitoring includes signal quality monitoring and the identifying includes identifying data representative of satellite failure.

In some applications, the comparing includes comparing data from both GNSS and non-GNSS sources.

In some applications, the method further includes triggering an indicator of spoofing of one or more of the plurality of GNSS signals upon identification of the outlying data.

In some applications, excluding the data includes providing a nullifying signal selected to nullify the GNSS signal bearing the outlying data.

In some applications, the identifying includes detecting variations in cross-correlated data received at multiple antennas.

In some applications, one aspect of the invention features a method of triggering an indicator of GNSS signal spoofing. The method includes logging a carrier-to-noise ratio (C/N0) time history for a plurality of GNSS signals; monitoring the plurality of GNSS signals; identifying a phenomenon or outlying data in one of the plurality of GNSS signals; and triggering an indicator of spoofing of one or more of the plurality of GNSS signals upon identification of the phenomenon or outlying data.

In some applications, identifying a phenomenon or outlying data comprises identifying a shift in a phase of a measured GNSS navigation data bit sequence.

In some applications, identifying a phenomenon or outlying data comprises identifying a profile phenomenon of a correlation function resulting from correlation of the incoming GNSS signals with a local signal replica.

In some applications, the profile phenomenon is the presence of multiple sustained correlation peaks.

In some applications, the identifying includes comparing respective signal processing observables of the plurality of GNSS signals. In some instances, the observable includes at least one of a code phase, a carrier phase, a carrier frequency, a navigation data bit sequence phase, and a correlation function profile.

In some applications, the comparing further comprises comparing a GNSS signal processing observable with at least one of a signal time-of-arrival, signal angle-of-arrival, a carrier frequency, and a data bit sequence phase of a non-GNSS radionavigation signal. In some cases, the non-GNSS signal is one of a LORAN signal, ELORAN signal, Radar signal, IRIDIUM™ signal, HDTV signal, a television broadcast signal, cellular telephone signal, WiFi signal, and NIST timing signal. In some cases, the non-GNSS signal is a radio frequency signal containing a navigation or time-bearing signature including at least one of a time of arrival, a carrier frequency, and a data bit sequence phase.

In some applications, the non-GNSS signal processing observable is derived from a local inertial measurement unit containing at least one of position, velocity, and acceleration observables. In some cases, the non-GNSS signal processing observable is time from a local reference clock.

In some applications, determining spoofing signatures includes factoring in a pre-defined probability of false alarm.

In some applications, the signal processing of observables is implemented in software on a self-contained GNSS receiver. In some applications, the signal processing of observables is implemented in software in a device interposed between a GNSS receiver antenna and a GNSS receiver. In some implementations, the signal processing of observables is implemented as a hardware solution or as a combination of hardware and software. For example, the signal processing can be implemented as software running on a DSP or it may be implemented as hardware or a combination of hardware and software, e.g., as an FPSG or ASIC solution.

In some applications, another aspect of the invention features a method of countering GNSS signal spoofing. The method includes detecting a phenomenon or outlying data indicative of signal spoofing in a compromised one of a plurality of GNSS signals and initiating a spoofing countermeasure upon detection of the phenomenon or outlying data. The countermeasure includes excluding a signal processing observable for the compromised signal from an estimator configured to fuse one or more signal processing observables to produce a full navigation solution.

In some applications, the full navigation solution is based on a sequential nonlinear least squares estimator (i.e., extended Kalman filter) configured to relate antenna position and velocity and receiver time data to signal processing observables of non-compromised signals.

In some applications, the method further includes synthesizing, using the navigation solution, one or more radio-frequency GNSS signals via a GNSS signal simulator. In some instances, the method further includes inputting the one or more synthesized radio-frequency GNSS signals into a compatible GNSS receiver.

In some applications, the method further includes substituting navigation or timing data for the excluded observable, wherein the navigation or timing data is derived from a non-GNSS signal.

In some implementations, another aspect of the invention features a GNSS signal receiver; a GNSS signal antenna; and a GNSS signal monitor between the antenna and a GNSS signal receiver, the GNSS signal monitor is configured to detect a compromised GNSS signal, e.g., spoofing or counterfeit signal. The GNSS signal monitor, e.g., Spoofing Detector can also detect a phase shift in the signal or can detect variations in cross-correlated data received at multiple antennas, e.g., variations in embedded encrypting sequences or other associated signal data. Examples of detection of spoofing using multiple antennas are described in U.S. Pat. No. 5,557,284, issued Sep. 17, 1996 and titled Spoofing Detection System for a Satellite Positioning System, which is incorporated herein by reference in its entirety.

In some implementations, the system includes a GNSS data synthesizer configured to synthesize navigation and timing data from a plurality of signals into a navigation solution to substantially compensate for the compromise of the GNSS signal.

In some implementations, the GNSS signal monitor is configured to identify a phenomenon of a shift in a phase of a measured GNSS navigation data bit sequence.

In some implementations, the GNSS signal monitor is configured to identify a phenomenon of a correlation function resulting from correlation of the incoming GNSS signals with a local signal replica.

In some implementations, the system includes a signal spoofing indicator. In some cases, the spoofing indicator is one of an electronic signal, an audible signal, a tactile signal and a visual signal. In a particular implementation, the spoofing indicator is an electronic signal operable to initiate a connection between a Multi-system Receiver and Spoofing Protection Device and a target GPS receiver.

In some implementations, the plurality of signals includes at least one non-GNSS signal, and the system further includes at least one of a baseband input and a second antenna for input of the at least one non-GNSS signal.

In some applications, the invention includes a method of countering GNSS signal spoofing. The method includes detecting a phenomenon indicative of signal spoofing in a compromised one of a plurality of GNSS signals. The method further includes determining an amplitude of a compromised GNSS signal, generating a nullifying signal having an amplitude that is complementary to the amplitude of the compromised signal; and superimposing the nullifying signal over the compromised GNSS signal such that the complementary amplitude substantially nullifies the compromised GNSS signal.

The details of one or more implementations of the invention are set forth in the accompanying drawings and the description below. Other features, objects, and advantages of the invention will be apparent from the description and drawings, and from the claims.

### DESCRIPTION OF THE DRAWINGS

FIG. 1 is a block diagram of a GNSS navigation system employing auxiliary non-GNSS signals.

FIG. 2 is a block diagram of a GNSS navigation receiver.

FIG. 3 is a functional block diagram of a GNSS Multi-system Receiver and Spoofing Detector.

FIG. 4 illustrates operation of components of the Multi-system Receiver and Spoofing Detector.

FIG. 5 is a flow diagram of a detection decision module.

FIG. 6 illustrates a method of countering GNSS signal spoofing.

Like reference symbols in the various drawings indicate like elements.

### DETAILED DESCRIPTION

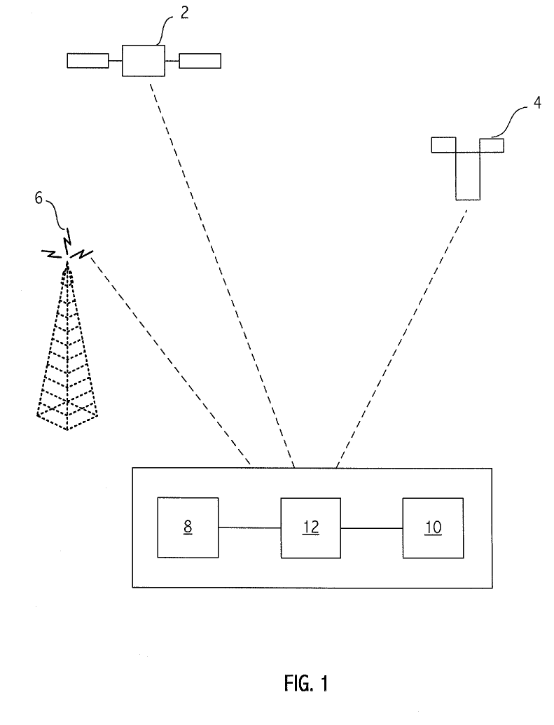

With reference to FIG. 1, a GNSS navigation receiver 10 is capable of providing a positional and/or timing solution based on signals from one or more GNSS satellites 2. A Multi-system Receiver and Spoofing Protection Device 8 is configured to receive signals from one or more GNSS satellites 2, non-GNSS satellites 4, and/or terrestrial RF sources 6 and to detect compromise of one of the GNSS satellite signals. In some implementations, detection of signal compromise by a Multi-system Receiver and Spoofing Protection Device 8 can be used to alert a user of the compromise. In some implementations, such detection can also be used to initiate selective provision of non-compromised signals to GNSS navigation receiver 10 via a GNSS synthesizer module 12. GNSS synthesizer module 12 can pass non-compromised signals or signal data on to an RF input of GNSS navigation receiver 10 and can exclude or replace compromised signal data with data synthesized at least in part from other than the compromised signal source.

For example, in some applications, the non-GNSS satellite 4 is a LEO satellite, e.g., IRIDIUM™ satellite, providing data useful to GNSS anti-spoofing module 8 and GNSS synthesizer module 12 in providing timing, positional or navigational solution useful data to GNSS navigation receiver 10.

While the Multi-system Receiver and Spoofing Protection Device 8 and GNSS synthesizer module 12 are depicted as separate components, the GNSS synthesizer module 12 may be integrated with the Multi-system Receiver and Spoofing Protection Device 8 or both may be integrated with GNSS navigation receiver 10.

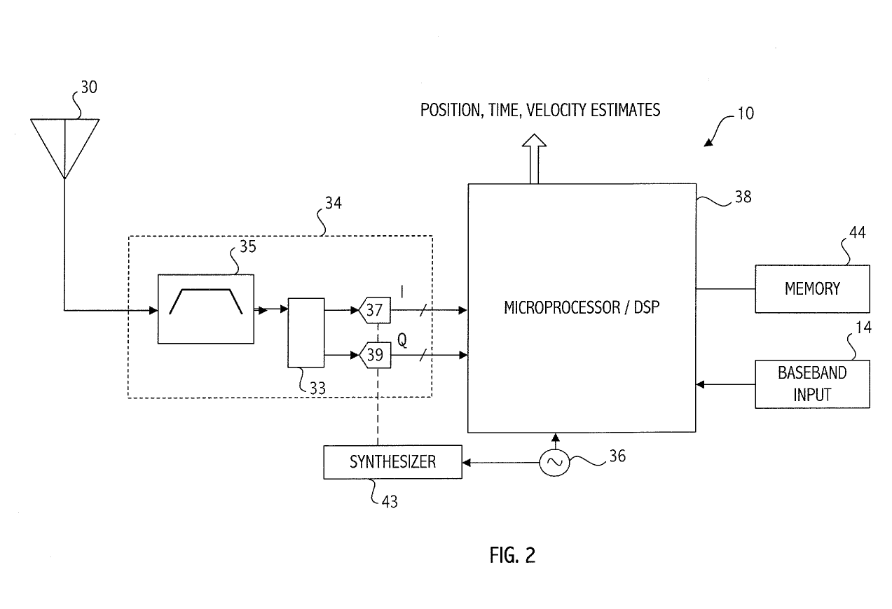

With reference to FIG. 2, the basic architecture for a GNSS navigation radio 10 includes a multi-system antenna 30 to receive the satellite signals and other RF signals, front end 34 including a bandpass filter 35, preamp and a clock 36, e.g., reference crystal oscillator. The RF front-end 34 draws in signals from the multi-system antenna 30 and filters, mixes, and digitizes the signals. The output of the RF front-end 34 is a stream of digital data samples that are routed to the digital signal processor (DSP) 38. Structurally, the DSP 38 processes computer programming instructions stored in memory 44, e.g., to determine navigation radio position. DSP 38 may also receive baseband input such as inertial measurements, a time synchronization pulse, or PVT input from a user.

A synthesizer 43 provides a coherent sine wave and clock signals to be used by other radio components based on a clock signal received by the synthesizer. For example, an inertial sensor provides accelerometer and rate-gyro baseband inputs 14 synchronized to receiver clock 36 and may be used to provide raw digital motion samples. GNSS navigation receiver 10 calculates an estimate of the bias of navigation radio clock 36 to compensate for measured errors in a satellite clock, reference station clock, multiple receiver clocks and/or time slot changes in a transmission sequence and the like. Some implementations include RF front end 34 that downconvert to an intermediate frequency (IF), however, a direct downconversion to baseband may be used.

The front end 34 of the receiver 10 downconverts the received RF signal into an intermediate frequency signal which is output to the DSP 38. The front end 34 can carry out various bandpass, automatic gain control (AGC), direct RF sampling and A/D conversion functions and may use direct or traditional in-phase and quadrature downconversion schemes. For example, a hybrid coupler 33 can separate the signal into in-phase and quadrature components and A/D converters 37, 39 can sample incoming in-phase and quadrature signals and output to DSP 38 digital data useful to derive a range observable. For example, DSP 38 can derive at least one of a pseudorange, carrier phase or Doppler shift range observable for a corresponding satellite. DSP 38 can determine a clock offset between clock 36 and a satellite reference clock. DSP 38 may perform any number of routines with received signals or data including extracting ephemeris information for a corresponding satellite.

Memory 44 stores data and computer programming instructions for processing. Memory 44 may be an EEPROM chip, electromagnetic device, optical storage devices, or any other suitable form or type of storage medium. Memory 44 can store, inter alia, ephemerides for the corresponding satellite, local terrain data, and any type of data derived from the received RF signals, inertial sensor or other sensor outputs, user inputs, or other suitable data source. For example, in some cases, satellite ephemerides are transmitted or obtained through other than a satellite signal, e.g., via a ground reference station or over a wireless network connection.

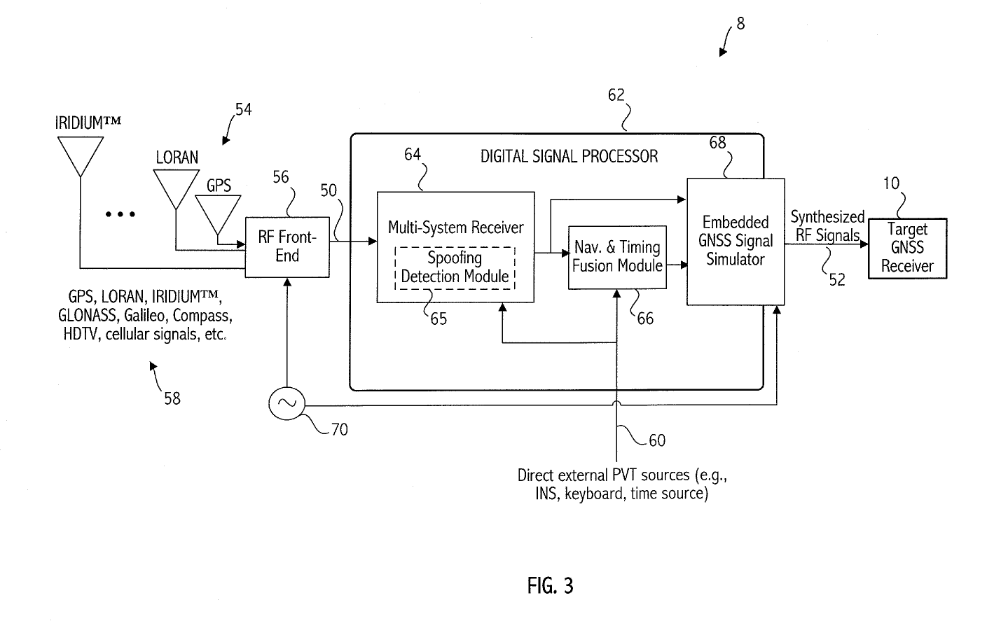

In some implementations, Multi-system Receiver and Spoofing Protection Device 8 may be implemented, at least in part, as a GNSS anti-spoofing module incorporated within receiver 10, e.g., as software instructions operable on DSP 38. With reference to FIG. 3, however, Multi-system Receiver and Spoofing Protection Device 8 is described as a standalone device connectable to a target GNSS navigation receiver 10. Multi-system Receiver and Spoofing Protection Device 8 includes one or more input ports 50 and an RF output 52. Antennas 54 connected to the RF front end 56 receive navigation- or time-bearing RF signals 58 present in the Anti-Spoofing Module's environment. Another input 60 is available for receiving external PVT information provided at baseband such as inertial measurements, a time synchronization pulse, or PVT input from a user. The Multi-system Receiver and Spoofing Detector RF output 52 is connected to the RF input of an existing GNSS navigation receiver 10 (the target receiver). Multi-system Receiver and Spoofing Protection Device 8 may also be coupled to the baseband input 14 of navigation receiver 10.

In some implementations, the Multi-system Receiver and Spoofing Protection Device 8 includes a digital signal processor 62 upon which are implemented Multi-system Receiver and Spoofing Detection Module 64, a Navigation and Timing Fusion Module 66 and the digital processing component of an Embedded GNSS Signal Simulator 68. (The embedded GNSS signal simulator 68 is depicted in FIG. 1 as residing partly outside the digital signal processor 3 because it includes an external RF upconversion component.) Multi-system Receiver and Spoofing Detection Module 64 extracts navigation and timing information from the RF signal input and from the baseband PVT input and outputs the navigation and timing information to Navigation and Timing Fusion Module 66 and Embedded GNSS Signal Simulator 68 as described in more detail below.

A bank of RF front ends 56 filters, mixes, and digitizes electromagnetic navigation- or time-bearing signals in the vicinity of the Multi-system Receiver and Spoofing Protection Device 8, including, but not limited to:

(a) GPS signals

(b) GALILEO signals

(c) GLONASS signals

(d) BEIDOU/COMPASS signals

(e) SBAS signals (e.g., WAAS, EGNOS)

(f) LORAN signals

(g) ELORAN signals

(h) IRIDIUM™ signals

(i) HDTV signals

(j) Cellular telephone signals

(k) WiFi and WiMax signals

(l) NIST timing signals

The output of the RF front-end bank 56 is a stream of digital data samples that is routed to the Multi-system Receiver and Spoofing Detection Module 64. For synchronization, the RF front-end bank 56 and the embedded GNSS signal simulator 68 are tied to a common reference oscillator 70.

Multi-system Receiver and Spoofing Detection Module 64 is capable of processing and extracting navigation and timing data from a diverse set of RF signals for which combined digitized data are output by the RF front-end bank 56. Spoofing detector routines within this module determine which GNSS signals are potentially being spoofed. Multi-system Receiver and Spoofing Detection Module 64 produces spoofing-free GNSS carrier and code phase measurements and GNSS carrier frequency measurements, which are routed to the Embedded GNSS Signal Simulator 68 for phase alignment of the synthesized GNSS signals with ambient GNSS signals. Multi-system Receiver and Spoofing Detection Module 64 can function as a software radio based on techniques such as those described in U.S. Pat. Nos. 7,010,060 and 7,305,021, which are incorporated herein by reference in their entireties.

Navigation and Timing Fusion Module 7 employs estimation techniques, e.g., Kalman filtering techniques, to combine external PVT data from Direct external PVT sources 60, e.g., baseband input from an inertial navigation system, an external clock, or a keyboard, with the extracted navigation and timing observables to produce a robust PVT solution that serves as an input to the Embedded GNSS Signal Simulator 68.

Multi-system Receiver and Spoofing Detection Module 64 and Embedded GNSS Signal Simulator 68 may provide a range of GNSS security and performance enhancement measures, some of which are described below. The GNSS Embedded Signal Simulator 68 is described in more detail below and in Applicants' copending application Ser. Nos. ______ and ______, filed Sep. ______, 2010, titled, respectively, “Simulating Phase-Coherent GNSS Signals” and “Assimilating GNSS Signals to Improve Accuracy, Robustness, and Resistance to Signal Interference,” which are hereby incorporated in their entireties by reference.

Spoofing Detection

The Multi-system Receiver and Spoofing Detection Module 64 continuously analyzes the incoming data stream to detect spoofing signatures. Multi-system Receiver and Spoofing Detection Module 64 employs statistical hypothesis testing to determine when to trigger an indicator signaling the presence of spoofing.

The hypothesis testing method indicates the presence of spoofing with a pre-defined probability of false alarm. To determine whether any particular GNSS signal is being spoofed, the hypothesis test can take into account the carrier-to-noise ratio (C/N0) time history for the GNSS signals being considered for the presence of spoofing.

In various implementations, Multi-system Receiver and Spoofing Detection Module 64 uses the C/N0 and one or more of the following detector techniques, phenomenon or “Methods” to determine if a GNSS signal contains spoofing:

(1) Detection of outlying data indicative of sudden shifts in the phase of the measured GNSS navigation data bit sequence. For example, a data bit latency defense.

(2) Detection of the presence of multiple sustained correlation peaks for a particular GNSS signal. For example, outlying data of a vestigial signal in one of a code and carrier Doppler shift frequency can indicate spoofing.

(3) Comparison with all other GNSS signals' code phase, carrier phase, or carrier frequency, navigation data bit sequence phase, and correlation function profile observables.

(4) Comparison with non-GNSS navigation and time-bearing signals' code phase, carrier phase, or carrier frequency, and data bit sequence phase observables.

(5) Comparison with other radio frequency signals' (not expressly designed for navigation or timing) time of arrival, carrier frequency and data bit sequence observables.

(6) Comparison with position, velocity, and acceleration observables from a local inertial measurement unit.

(7) Comparison with time from a local reference clock.

(8) Signal quality monitoring for verification of a signal's structure and integrity.

(9) Detect a phase shift in a GNSS signal or variations in cross-correlated data received at multiple antennas. For example, variations in phase shift, satellite receiver geometry or other associated signal data may indicate a spoofing attempt.

Method 1 considers the fact that a spoofer has difficulty estimating the navigation data bits and then retransmitting them without delay. This leads to a lag in the data bit phase, which can be detected by employing Method 1 to use the multi-signal receiver module's correlator, tracking loops, and navigation data decoding modules. Nominally, the navigation data bit phase changes occur at predefined times and by bounded quantities. For high C/N0, any sudden shift in the navigation data bit phase can be ascribed to spoofing activity. Method 1 can be formulated as a hypothesis test to look for sudden phase shifts that are larger than a threshold calculated using hypothesis testing techniques.

Method 2 considers that when tracking a GNSS signal, only a single sustained peak associated with the cross-correlation of the local code replica and carrier replicas and the incoming RF data stream is present. The presence of additional sustained cross-correlation peaks indicates the presence of additional GNSS signals in the incoming RF data stream.

Method 3 considers that the authentic GNSS observables are mutually consistent. That is, the authentic GNSS observables all constitute a single navigation and timing solution. Observables that are inconsistent are discarded from the navigation position, velocity, and time solution of the Anti-Spoofing Module. In some implementations, one such approach is receiver autonomous integrity monitoring (RAIM). A RAIM module can exclude outlier data from sets of measurements from multiple satellites. Similarly, GNSS signal quality monitoring may be used to identify phenomenon, outlying data or other features of the signals that are problematic or representative of satellite failure as an indication of potential spoofing.

Method 4 considers that other non-GNSS observables that provide navigation and time-bearing information are consistent with the authentic GNSS observables. Observables that are inconsistent are discarded from the position, velocity, and time solution of the Anti-Spoofing Module.

Method 5 considers that other non-GNSS observables that provide navigation and time-bearing information, but were not expressly designed for navigation and timing, are consistent with the authentic GNSS observables. Observables that are inconsistent are discarded from the position, velocity, and time solution of the Anti-Spoofing Module.

Method 6 considers that other sources of position and velocity and acceleration can be compared against compatible estimates derived from GNSS, non-GNSS, and other radio frequency signals that carry navigation or time-bearing information.

Method 7 considers that time or frequency reference from an external source can provide timing information that can be compared against compatible estimates derived from GNSS, non-GNSS, and other radio frequency signals that carry navigation or time-bearing information.

Method 8 considers that techniques developed for signal quality monitoring of GNSS satellite can be applied to spoofing signal detection. These techniques perform verification of a signal's structure and integrity based on the known signal structure and identified potential satellite sub-system failure modes. Deviations in the received broadcast GNSS signals can indicate the presence of an on-going spoofing attack.

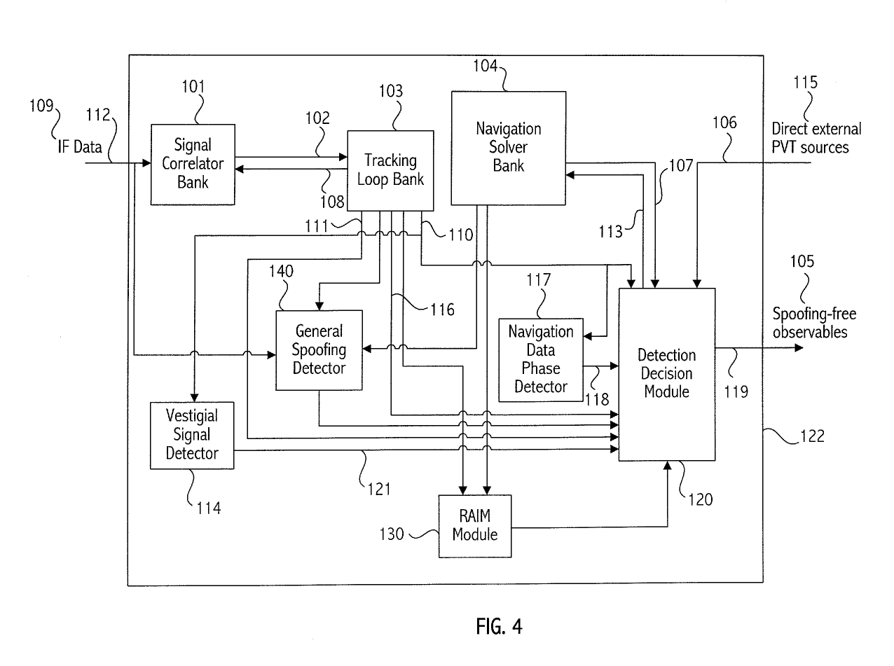

FIG. 4 illustrates additional components used in Multi-system Receiver and Spoofing Detection Module 64 including a signal correlator bank 101, tracking loop bank 103, and a multi-system navigation solver bank 104.

Signal Correlator

The signal correlator bank 101 correlates local carrier and code replicas with the incoming digital data samples 112 to produce complex baseband signal components 102. Signal correlator bank 101 is controlled by the tracking loop bank 103 using carrier frequency and code frequency commands 108.

This method works with GNSS, non-GNSS, and other navigation and time-bearing radio signals.

Tracking Loops

The outputs of the signal correlator 102 are fed into tracking loop bank 103 that outputs C/N0, carrier and code phase, carrier frequency, navigation data observables, and correlation profile for GNSS signal observables 110. The tracking loop bank 103 outputs carrier and code phase, carrier frequency, and data bit observables, for non-GNSS signals 110. The tracking loop bank 103 outputs time of arrival, carrier frequency, and data bit observables, for other navigation- and time-bearing signals 116.

Vestigial Signal Detector

The GNSS signal observables 110 are input into the vestigial signal detector 114, which implements detector Method 2. The output of the vestigial signal detector 121 is fed into the detection decision module 120.

Navigation Data Phase Detector

The observables 110 are input into the vestigial signal detector 117, which implements detector Method 1. The output of the navigation data phase detector 118 is fed into the detection decision module 120.

Multi-System Navigation Solver

The navigation solver bank 104 is utilized by the detection decision module 120 to carry out tasks of computing navigation solutions. A set of observables and direct external PVT data 113, 115 is input into the navigation solver bank 104 via input 113. The navigation solver bank 104 returns a position, time, and velocity estimate 107. Alternately, the navigation solver bank 104 can be implemented as a navigation and timing fusion module as described in Applicants' copending application titled “Simulating Phase-Coherent GNSS Signals.”

Detection Decision Module

The detection decision module 120 takes as input GNSS observables 110, non-GNSS observables 111, other navigation- and time-bearing radio frequency observables 116, the output of the navigation data phase detector 118, the output of the vestigial signal detector 121, direct external PVT source data 106, and the navigation solver output 107 to formulate one or more hypothesis tests that determines which GNSS signals are being spoofed. Detection decision module 120 outputs spoofing-free observables 105 via output 119.

RAIM Module

Receiver autonomous integrity monitoring (RAIM) module 130 receives data from Tracking Loop Bank 103 and Navigation Solver Bank 104 and provides data to the Detection Decision Module 120. For example, RAIM module 130 can evaluate carrier Doppler and code phase data from multiple satellites and exclude outlier data as potentially spoofed data.

General Spoofing Detector

A General Spoofing Detector 140 may employ any number of suitable spoofing detection techniques to aid Detection Decision Module 120 in identifying potential spoofing. General Spoofing Detector 140 may employ inputs from any of Navigation Solver Bank 104, IF data 112, Tracking Loop Bank 103 or other modules or inputs to aid in detecting spoofing. For example, General Spoofing Module 140 may monitor the quality of a signal.

RF Front-End

The radio frequency (RF) front-end 56 draws in signals from the antennas 54 and filters, mixes, and digitizes the GNSS signals. The output of the RF front-end 56 is a stream of digital data samples that is routed to the Multi-system Receiver and Spoofing Protection Device 8. The RF front-end 56 and the RF upconversion module are tied to a common reference oscillator 70.

GNSS Signal Simulator

In an embedded GNSS signal simulator implementation, a digital signal processing component can be implemented along with the Multi-system Receiver and Spoofing Detection Module 64 and the Navigation and Timing Fusion Module 66 on a single digital signal processing platform 62. The Embedded GNSS Signal Simulator 68 generates multiple GNSS signals implying a navigation and timing solution substantially consistent with a commanded position, velocity, and time, similar to the operation of a testing GNSS signal simulator.

In a particular implementation, the Embedded GNSS Signal Simulator 68 is a specialized phase-coherent GNSS signal simulator. This type of simulator generates multiple GNSS signals that, if broadcast from the location of the simulator's radio frequency output, would have carrier and code phases that are aligned with the carrier and code phases of the corresponding authentic GNSS signals at a nearby location specified by the user. Additional phase coherent implementation details are found in Applicants copending application Ser. No. ______, filed Sep. ______, 2010, titled “Simulating Phase-Coherent GNSS Signals,” which is incorporated herein in its entirety by reference.

RF Upconversion Module

With reference to FIG. 3, Embedded GNSS Signal Simulator 68 includes an RF Upconversion Module configured to upconvert input signal to L-band. For example, an output bitstream of a sample-wise combiner is routed to an RF upconversion module comprising a digital-to-analog converter, frequency mixers, filters, and a signal attenuator. The upconversion module converts the digital signal into a set of synthesized GNSS signals. A reference oscillator that drives the RF upconversion module is also the reference oscillator for a coupled receiver's RF front-end.

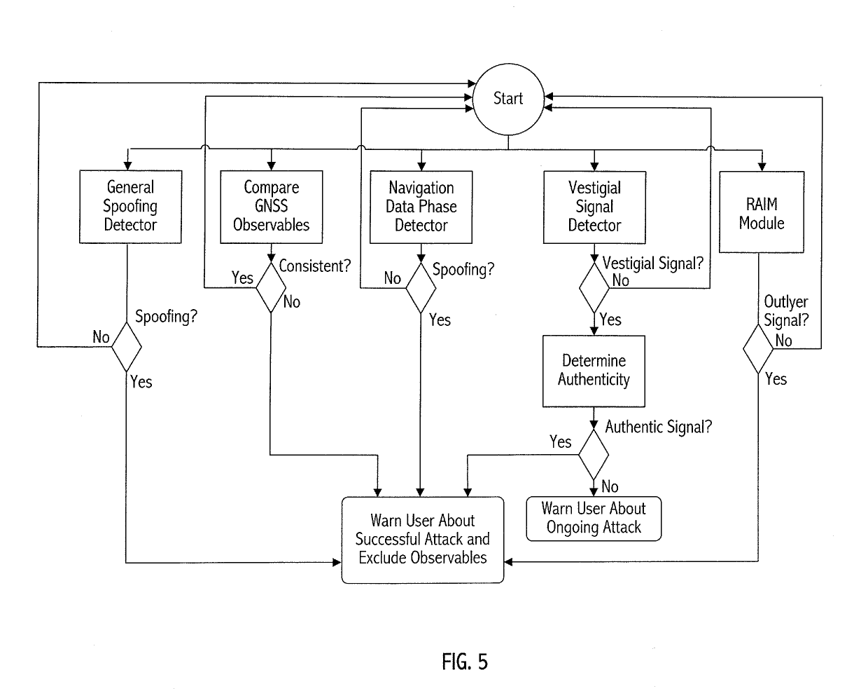

FIG. 5 illustrates one example process of the decision-making within the detection decision module 120. The flow diagram takes into consideration various inputs to 120 including the GNSS observables 110, non-GNSS observables 111, other observables 116, the output of the vestigial signal detector 121, the output of the navigation data phase detector 118, the direct external PVT sources 115, the output of the navigation solver bank 107, the output of the RAIM Module 130 and/or General Spoofing Module 140 to determine, using hypothesis testing, if a GNSS signal is being spoofed. The output from the navigation solver bank 107 may be the result of a query to the navigation solver bank 107 that is used to compare all available or a subset of all available observables.

The hypothesis test can be constructed as one or more sequential tests or a multi-variate test. For example, any number of the three illustrated spoofing detection methods may be implemented individually or in parallel. Upon detection of spoofing by one or more of the Methods, the user is warned about a successful or attempted spoofing attack. Based on such an indication of spoofing, various countermeasures can be implemented as described.

In a particular implementation, one countermeasure includes nullifying a counterfeit spoofing signal from the digital IF data by tracking the signal and generating a nullifying replica of the signal and adding the nullifying signal replica to the IF data to nullify the counterfeit signal. Thus, all the IF data can be passed while problematic portions are zeroed out by the nullifying signal. This countermeasure simplifies the system because adding the nullifying signal requires lower computing and power loads than synthesizing all new signals.

In some implementations, additional countermeasures can include verifying authentication messages embedded in GNSS signals.

In some implementations, the Multi-system Receiver and Spoofing Protection Device 8 may also be useful in the following scenarios: signal obstruction or jamming, spoofing, and GNSS modernization.

Signal Obstruction or Jamming

When the signal-to-noise ratio within a GNSS receiver falls below a certain threshold, either because the GNSS signal is obstructed or because a jamming attack is underway, the user can be presented with a “Need clear view of sky” or similar notice from the receiver. At this point, the receiver-produced PVT data either rapidly deteriorate in accuracy or the data stream abruptly halts. Obviously, a better outcome in such weak-signal or jammed environments would be for the receiver-produced PVT data to deteriorate only mildly, if at all. This is what is meant by robust PVT.

When coupled to the Multi-system Receiver and Spoofing Protection Device 8, existing GNSS user equipment would be capable of delivering robust PVT. This is because the Multi-system Receiver and Spoofing Protection Device 8 is not limited to deriving PVT information from, for example, GPS signals. Rather, it can behave opportunistically, extracting navigation and timing information from other RF signals in the environment—including those from other GNSS—or from baseband data sources such as an inertial navigation system, an external synchronization signal, or from the user himself.

Some of the additional available RF signals can be radionavigation signals (e.g., other GNSS or ELORAN signals) with a signal-to-noise ratio higher than those the target receiver is natively capable of tracking, whether because the signals are unobstructed, or intrinsically of higher power, or because their carrier frequency falls outside the jammed frequency range. Yet other available RF signals may not be radionavigation signals as such, but may nonetheless carry implicit navigation or timing data. For instance, television signals, cellular telephone signals, and satellite communication signals can be exploited by the Multi-system Receiver and Spoofing Protection Device for navigation and timing.

From available navigation- or time-bearing RF signals, or from baseband data input by the user or by external devices, the Multi-system Receiver and Spoofing Protection Device 8 optimally estimates its PVT state. Consistent with this PVT state, the Multi-system Receiver and Spoofing Protection Device 8 continuously generates a target-receiver-compliant set of RF GNSS signals and injects this into the target receiver's RF input. To generate the synthesized GNSS signals, the Multi-system Receiver and Spoofing Protection Device 8 employs a GNSS signal simulator utilizing the same clock as the Multi-system Receiver and Spoofing Detector. In some embedded applications, the GNSS signal simulator can be implemented on a single digital signal processor together with the other components of the Multi-system Receiver and Spoofing Detector.

In one implementation, the embedded GNSS signal simulator is a special phase-coherent GNSS signal simulator capable of replicating ambient authentic GNSS signals and phase-aligning to these signals. Such phase alignment implies that the synthesized signals appear exactly as the authentic signals to the target receiver, which means that the Multi-system Receiver and Spoofing Protection Device can be seamlessly “hot plugged” into a target receiver without interrupting or degrading the target receiver's PVT solution.

In a complete GNSS signal blackout, the PVT data produced by the coupled Multi-system Receiver and Spoofing Detector and target receiver will eventually degrade, but by leveraging non-GNSS navigation and timing sources, the Multi-system Receiver and Spoofing Protection Device 8 limits this degradation substantially.

Spoofing

Stand-alone commercial civilian GNSS receivers available today can be readily spoofed. One simply attaches a power amplifier and an antenna to a GNSS signal simulator and radiates the RF signal toward the target receiver.

Military-grade GNSS receivers are capable of operating in a spoof-resistant mode in which the receiver tracks an encrypted ranging code for which a pattern is unpredictable except to compliant and keyed user equipment. However, in practice, many military personnel fail to maintain the cryptographic keys in their GNSS user equipment or prefer to carry civil GNSS receivers, with the result that a large fraction of GNSS receivers in military service are vulnerable to spoofing.

The Multi-system Receiver and Spoofing Protection Device 8 detects the presence of GNSS spoofing by employing spoof detection methods and by validating incoming GNSS signals against other available navigation and timing sources, such as those described above.

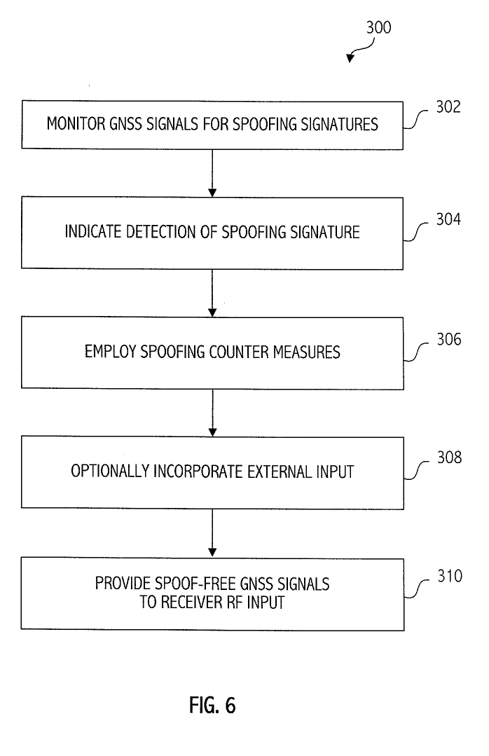

With reference to FIG. 6, a Multi-system Receiver and Spoofing Protection Device 8 may be used in a method to mitigate or counter effects of GNSS signal spoofing. (300)

Multi-system Receiver and Spoofing Protection Device 8 monitor GNSS signals for spoofing signatures as described with reference to FIG. 5. (302)

Upon detection of a spoofing signature, Multi-system Receiver and Spoofing Protection Device 8 indicates detection of spoofing. (304) Multi-system Receiver and Spoofing Protection Device 8 can optionally initiates an alarm and/or a connection of Multi-system Receiver and Spoofing Protection Device 8 to GNSS navigation receiver 10, e.g., to an RF input of the receiver.

Multi-system Receiver and Spoofing Protection Device 8 then employs one or more spoofing countermeasures. (306) For example, it may synthesize GNSS signals from diverse PVT information sources, e.g., including non-GNSS RF signals, and excluding spoofed signal data. External input, e.g., inertial measurement unit data or user input data, may be optionally incorporate in the countermeasures employed. (308). Thus, Multi-system Receiver and Spoofing Protection Device 8 can provide spoof-free synthesized GNSS signals to the GNSS navigation receiver. (310)

Once the Multi-system Receiver and Spoofing Protection Device 8 detects a spoofing attack, it can alert the user and/or exclude the spoofing signals from its internal PVT estimate. The synthesized GNSS signals that the Multi-system Receiver and Spoofing Protection Device 8 continuously sends to the target receiver are accordingly spoof-free, and the target receiver is protected from the spoofing attack.

In an alternative implementation, the Multi-system Receiver and Spoofing Protection Device 8 incorporates a full GPS Selective Availability Anti-Spoofing (SAASM) module, providing military-grade spoofing protection to any target receiver, whether military or civil. This option can be advantageous, for example, to military users who demand military-grade security against spoofing but prefer the user-friendly interface of commercial civil user equipment.

In another implementation, the Multi-system Receiver and Spoofing Protection Device 8 initially acts as a stand-alone spoofing detector, uncoupled from any target receiver. When a spoofing attack is detected, the Multi-system Receiver and Spoofing Detector raises an alarm and an unprotected GNSS receiver can then be coupled to the Multi-system Receiver and Spoofing Detector for protection against the attack.

This implementation would be attractive to users who are wary of spoofing but who otherwise prefer an untethered GNSS receiver.

GNSS Modernization

Modernized GPS offers a ten-fold improvement in civil ranging precision, improved military signal precision and integrity, and greater frequency diversity than legacy GPS. For example, the Russian GLONASS system is rapidly being replenished and will soon reach full operational capability; the Chinese Beidou/Compass system has an ambitious launch schedule that will populate the constellation within the next few years; and, despite some initial setbacks, the European Galileo system will likely be fully deployed within the next decade.

To directly harness the improved accuracy, availability, and redundancy that these modern GNSS offer, military and civilian GNSS users must generally abandon existing equipment as obsolete and replace it, at significant expense, with newer equipment. The Multi-system Receiver and Spoofing Protection Device 8, however, delivers the benefits of GNSS modernization through augmentation, rather than replacement, of existing user equipment. The Multi-system Receiver and Spoofing Protection Device 8 can be configured to track numerous available modern GNSS signals. From these signals, it estimates a highly accurate PVT solution that it embeds in a set of synthesized GNSS signals with which the target GNSS receiver is natively compliant. The synthesized GNSS signals are generated by the Multi-system Receiver and Spoofing Protection Device mentioned above and injected into the RF input of the target GNSS receiver.

When coupled to a narrowband target GNSS receiver (an L1 C/A GPS receiver, for example), the Multi-system Receiver and Spoofing Protection Device 8 cannot pass on the full ranging precision of modern wideband civil signals such as the GPS L5 and the Galileo E5a and E5b signals. Nonetheless, the Multi-system Receiver and Spoofing Protection Device 8 significantly compensates for this limitation by synthesizing GNSS signals characterized by strong geometry and high signal-to-noise ratio to yield a high-precision PVT solution. Furthermore, the Multi-system Receiver and Spoofing Protection Device 8 is able to pass on the improved multipath immunity and orthogonality that modern GNSS signals offer, and, because it tracks signals at multiple GNSS frequencies, it can substantially eliminate ionospheric errors from the GNSS signals it synthesizes. Considering these benefits, one can readily appreciate that the PVT solution of a Multi-system Receiver and Spoofing Detector-aided legacy single-frequency narrowband target receiver will be nearly as accurate as that of a modern multi-frequency wideband GNSS receiver.

### Other Embodiments

While the invention(s) is (are) described with reference to various embodiments, it will be understood that these embodiments are illustrative and that the scope of the invention(s) is not limited to them. Many variations, modifications, additions, and improvements are possible. For example, while particular LEO satellite signals, receivers and sensors have been described in detail herein, other variations will be appreciated based on the description herein. Furthermore, while certain illustrative signal processing techniques have been described in the context of certain illustrative applications, persons of ordinary skill in the art will recognize that it is straightforward to modify the described techniques to accommodate other suitable signal processing techniques.

Embodiments may be provided as a computer program product, or software, that may be encoded in a machine-readable medium having using instructions, which may be executed in a computer system (or other electronic device(s) such as a digital processor of a navigation radio) to perform a navigation method in accordance with some embodiments of the present invention. In general, a machine readable medium can include any mechanism for encoding information in a form (e.g., software, source or object code, functionally descriptive information, etc.) readable by a machine (e.g., a computer) including tangible storage incident to transmission of the information. A machine-readable medium may include, but is not limited to, magnetic storage medium (e.g., disks and/or tape storage); optical storage medium (e.g., CD-ROM, DVD, etc.); magneto-optical storage medium; read only memory (ROM); random access memory (RAM); erasable programmable memory (e.g., EPROM and EEPROM); flash memory; or other types of medium suitable for storing electronic instructions, operation sequences, functionally descriptive information encodings, etc.

In general, plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method of countering GNSS signal spoofing, the method comprising:
monitoring a plurality of GNSS signals received from a plurality of GNSS signal sources;
comparing data broadcast in the plurality of GNSS signals;
identifying outlying data within a compared set of data; and
excluding the outlying data from generation of a navigation solution defined, at least in part, by the data broadcast in the plurality of GNSS signals.

2. The method of claim 1, wherein the monitoring includes receiver autonomous integrity monitoring (“RAIM”).

3. The method of claim 1, wherein the outlying data comprises a vestigial signal in one of a code and carrier Doppler shift frequency.

4. The method of claim 1, wherein the comparing includes logging a carrier-to-noise ratio (C/N0) time history for the plurality of GNSS signals and the identifying includes identifying sudden phase shifts larger than a predetermined threshold.

5. The method of claim 1, wherein the monitoring includes signal quality monitoring and the identifying includes identifying data representative of satellite failure.

6. The method of claim 1, further comprising comparing data from both GNSS and non-GNSS sources.

7. The method of claim 1, wherein excluding the data comprises superimposing a nullifying signal over the GNSS signal bearing the outlying data.

8. The method of claim 1, wherein the identifying includes detecting variations in cross-correlated data received at multiple antennas.

9. The method of claim 1, wherein identifying the outlying data comprises identifying a profile phenomenon of a correlation function resulting from correlation of the incoming GNSS signals with a local signal replica.

10. The method of claim 9, wherein the profile phenomenon is the presence of multiple sustained correlation peaks.

11. The method of claim 1, wherein the identifying includes comparing respective signal processing observables of the plurality of GNSS signals.

12. The method of claim 11, wherein the observable includes at least one of a code phase, a carrier phase, a carrier frequency, a navigation data bit sequence phase, and a correlation function profile.

13. The method of claim 11, wherein the comparing further comprises comparing a GNSS signal processing observable with at least one of a signal time-of-arrival, signal angle-of-arrival, a carrier frequency, and a data bit sequence phase of a non-GNSS radionavigation signal.

14. The method of claim 13, wherein the non-GNSS signal is one of a LORAN signal, ELORAN signal, Radar signal, IRIDIUM™ signal, HDTV signal, a television broadcast signal, cellular telephone signal, WiFi signal, and NIST timing signal.

15. The method of claim 13, wherein the non-GNSS signal is a radio frequency signal containing a navigation or time-bearing signature including at least one of a time of arrival, signal angle-of-arrival, a carrier frequency, and a data bit sequence phase.

16. The method of claim 13, wherein the non-GNSS signal processing observable is a local inertial measurement unit containing at least one of position, velocity, and acceleration observables.

17. A method of countering GNSS signal spoofing, the method comprising:
detecting a phenomenon indicative of signal spoofing in a compromised one of a plurality of GNSS signals;
initiating a spoofing countermeasure upon detection of the phenomenon, the countermeasure comprising excluding a signal processing observable for the compromised signal from an estimator configured to fuse one or more signal processing observables to produce a navigation solution.

18. The method of claim 17, wherein the full navigation solution is based on an estimator configured to relate antenna position and velocity and receiver time data to signal processing observables of non-compromised signals.

19. The method of claim 17, further comprising synthesizing, using the navigation solution, one or more radio-frequency GNSS signals via a GNSS signal simulator and inputting the one or more synthesized radio-frequency GNSS signals into a compatible GNSS receiver.

20. The method of claim 17, further comprising substituting navigation or timing data for the excluded observable, wherein the navigation or timing data is derived from a non-GNSS signal.

21. A GNSS signal security system comprising:
a GNSS signal receiver;
a GNSS signal antenna;
a GNSS signal monitor between the antenna and a GNSS signal receiver, the GNSS signal monitor configured to detect compromise of a GNSS signal; and
a GNSS synthesizer configured to synthesize navigation and timing data from a plurality of signals into a navigation solution to substantially compensate for the compromise of the GNSS signal.

22. The system of claim 21, wherein the GNSS signal monitor is configured to identify a vestigial signal in one of a code and carrier Doppler shift frequency.

23. The system of claim 21, wherein the GNSS signal monitor is configured to identify a phenomenon of a correlation function resulting from correlation of the incoming GNSS signals with a local signal replica.

24. The system of claim 21, further comprising a signal spoofing indicator including one of an electronic signal, an audible signal, a tactile signal and a visual signal.

25. The system of claim 24, wherein the spoofing indicator is an electronic signal operable to initiate communication by a spoofing countermeasure device with a target GNSS receiver.

26. The system of claim 21, wherein the plurality of signals includes at least one non-GNSS signal, the system further comprising at least one of a baseband input and a second antenna for input of the at least one non-GNSS signal.

27. A method of countering GNSS signal spoofing, the method comprising:
detecting a phenomenon indicative of signal spoofing in a compromised one of a plurality of GNSS signals;
determining an amplitude of a compromised GNSS signal;
generating a nullifying signal having an amplitude that is complementary to the amplitude of the compromised signal; and
superimposing the nullifying signal over the compromised GNSS signal such that the complementary amplitude substantially nullifies the compromised GNSS signal.
